(19) United States
(12) Patent Application Publication
(10) Pub. No.: US 2021/0084370 A1
(43) Pub. Date: Mar. 18, 2021

(54) COMPUTER SYSTEM AND METHOD FOR ESTIMATING VIEWERS OF ADDRESSABLE ADVERTISEMENTS

(71) Applicant: Xandr Inc., New York, NY (US)

(72) Inventor: Peter Campbell Doe, New York, NY (US)

(73) Assignee: Xandr Inc., New York, NY (US)

(21) Appl. No.: 17/018,770

(22) Filed: Sep. 11, 2020

Related U.S. Application Data
(60) Provisional application No. 62/899,203, filed on Sep. 12, 2019.

(51) Int. Cl. H04N 21/442; H04N 21/81; H04N 21/45; H04N 21/472; G06Q 30/02

(52) U.S. Cl. CPC H04N 21/44222; H04N 21/812; H04N 21/4532; G06Q 30/0269; G06Q 30/0201; G06Q 30/0204; G06Q 30/0242; H04N 21/47202

(57) ABSTRACT

Aspects of the subject disclosure may include, for example, obtaining delivery data, wherein the delivery data identifies a plurality of addressable objects to which media content has been delivered; obtaining research sample data, wherein the research sample data identifies, for each of a plurality of households, one or more household member characteristics associated with one or more members of the household who are assessed as having viewed the media content; selecting, as a target characteristic, a particular household member characteristic; and determining, based upon the delivery data and the research sample data, a numerical count, the numerical count being determined as an estimated number of viewers who had viewed the media content that had been delivered to the plurality of addressable objects and who have the target characteristic. Other embodiments are disclosed.

### CROSS REFERENCE TO RELATED APPLICATION(S)

This application claims priority to U.S. Provisional Application No. 62/899,203, filed Sep. 12, 2019. All sections of the aforementioned application(s) and/or patent(s) are incorporated herein by reference in their entirety.

### FIELD OF THE DISCLOSURE

The subject disclosure relates to a computer system and method for estimating viewers of addressable advertisements.

### BACKGROUND

“Linear television” refers to television (TV) that is watched with the originally-broadcast advertising inserted into ad breaks. Linear television includes both live pre-recorded and video on demand (VOD) television. This stands in contrast to TV with dynamically-inserted advertising, also referred to as addressable television. The television (TV) advertisement marketplace consists of buyers (e.g., TV advertising agencies) and sellers (e.g., TV content producers and distributors). A linear TV advertising campaign includes a series of video clips (each of which is referred to as a “creative”) placed in available time slots that sellers sell to buyers. Three related quantities describe, at a high level, the effectiveness of a linear TV advertising campaign: impressions, reach, and average frequency. For example, if 10 people watch a particular creative, and each such person watched that creative two times over the course of an advertising campaign, then the campaign will collect 20 impressions, a reach of 10 people, and an average frequency equal to 2. The mathematical relationship between these three quantities is:

Impressions=Reach*Average Frequency (1)

The quantity “impressions” may be replaced by another quantity that typically is referred to as ratings, which are the ratio of impressions to the estimated size of the target segment (also referred to as the “universe estimate”) expressed as a percentage. In the example above, if the estimated size of the target segment is 1,000, then the rating is 2 (100×20/1,000). In the description herein, impressions and ratings may be used interchangeably unless otherwise noted.

It can be challenging to measure the audience that is exposed to a particular advertisement (or other content) accurately or completely for a variety of reasons. For example, even if digital server information can provide counts, filtered for invalid traffic such as bots, of the number of times that a particular advertisement is delivered to televisions or other content delivery devices, the number and types of people (defined demographically or in terms of other consumer or behavioral criteria) watching that content at that time is unknown. Therefore, the mere knowledge that particular content was delivered to a particular content delivery device at a particular time does not make it possible to measure the relevant persons' audience that was exposed to that content. Conversely, dedicated audience measurement panels, which provide measurements of individuals' viewing via measurement technology such as people meters, will be based on relatively small samples of the population and return audience estimates that are subject to sampling error and other biases in overall delivery estimation.

### BRIEF DESCRIPTION OF THE DRAWINGS

Reference will now be made to the accompanying drawings, which are not necessarily drawn to scale, and wherein:

FIG. 1 is a dataflow diagram of a system for estimating exposures of content to one or more people according to one embodiment.

FIG. 2 is a flowchart of a method performed by the system of FIG. 1 according to one embodiment.

FIG. 3A depicts an illustrative embodiment of a method in accordance with various aspects described herein.

FIG. 3B depicts an illustrative embodiment of a method in accordance with various aspects described herein.

FIG. 3C depicts an illustrative embodiment of a method in accordance with various aspects described herein.

FIG. 3D is a block diagram of an example, non-limiting embodiment of a computing environment in accordance with various aspects described herein.

FIG. 4 is a block diagram of an example, non-limiting embodiment of a computing environment in accordance with various aspects described herein.

### DETAILED DESCRIPTION

In various embodiments, a computerized system automatically estimates the number of times that people were exposed on-screen to particular content (e.g., television programs, advertisements, or other video or display content) using a statistical integration of multi-signal data from one or more advertisement servers (and/or other census-based estimates of activity, such as set-top boxes) and panel-based individual measurement. The result is more accurate measurements of content exposure by individual people than was possible with certain previous techniques.

Various embodiments use a novel probabilistic approach to estimating viewing, applied at the individual respondent level to a privacy-compliant panel of individuals who measure relevant media consumption. Various embodiments estimate content consumption and exposure measures in a way that is contingent on known and/or forecast device activity from advertisement servers, set-top boxes, or similar entities. Various embodiments enable the number of unique and total exposures (i.e., reach and frequency) to be estimated across one or more content descriptors.

Various embodiments have a variety of advantages. For example, various embodiments can associate people with devices in a privacy-compliant way, enabling content producers and advertisers to understand how people consume content and their exposure to advertisements. This is becoming increasingly important as televisions become more connected and addressable, because televisions are viewed by different combinations of different numbers of people at different times.

For example, addressable televisions typically contain or have access to information about the viewers in the household in which the television is located. In one specific example, a television identifier can be integrated or imputed with information about the age, gender, income, and interests of each viewer in the household. When such an addressable television serves an advertisement, the television cannot identify directly which viewer(s) is/are watching that advertisement. Various embodiments, however, can estimate the number of times that specific individuals were exposed to specific advertisements (and other content) by addressable televisions, thereby providing (in various embodiments) a solution to the problem of being unable to identify directly the specific viewers who were exposed to particular content at particular times.

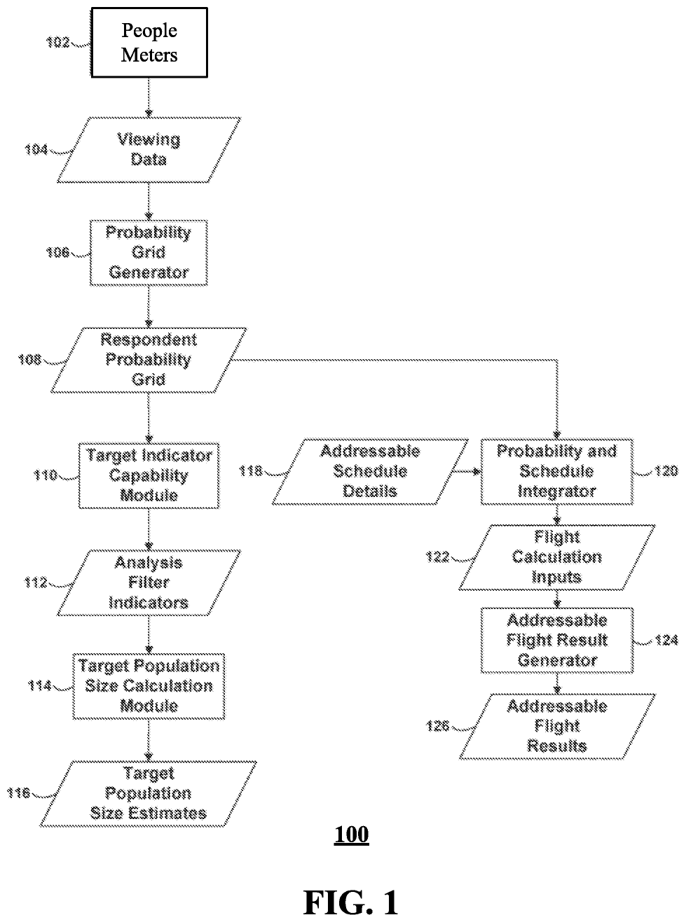

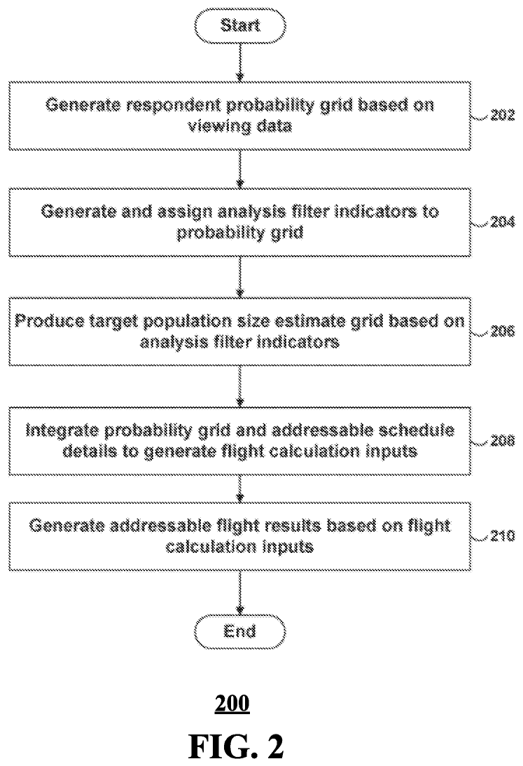

More specifically, referring to FIG. 1, a dataflow diagram is shown of a system 100 for estimating exposures of content to one or more people according to one embodiment. Referring to FIG. 2, a flowchart is shown of a method 200 performed by the system 100 according to one embodiment.

The system 100 includes a source of television viewing data 104, such as a people meter panel 102 or other similar system(s). The television viewing data 104 can, for example, include data representing viewing by one or more individual people and/or one or more households. The system 100 also includes a respondent probability grid generator 106, which receives the viewing data 104 as input and generates a respondent probability grid 108 as output (see, also, FIG. 2, operation 202). The respondent probability grid 108 can, for example, include probabilities that specific households and specific persons were exposed to specific content (e.g., Video on Demand (VOD) content). The respondent probability grid 108 can, for example, have household and person identifiers on one axis and content indicators on another axis, and each cell in the grid, corresponding to a particular household/content pair or particular person/content pair, can contain a probability that the household or person was exposed to the content. In addition, the respondent probability grid 108 can, for example, have a weight or projection factor which is applied to the individual panel members' measured advertising exposures in order to estimate population estimates of advertising exposures.

The probability grid generator 106 can calculate the probabilities in the respondent probability grid 108 in any of a variety of ways. For example, the probability grid generator 106 can calculate, for each pair of household/person and content, a probability p that the household/person was exposed to the content during a particular time period T as follows:
(1) Define Aᵢ as the number of daily available viewing minutes for each day i in time period T. For example, for networks, this is typically 1440 available viewing minutes per day.
(2) The number of weighted available minutes A is calculated as A=Σ(wᵢAᵢ) for each day i in time period T, where wᵢ is the weight for day i.
(3) The weighted viewed minutes M is calculated as M=Σ(wᵢMᵢ), where Mᵢ denotes the number of minutes viewed during day i for the viewing entity of interest, such as a network, a day-part, a program or set of programs.
(4) The probability p can be calculated as p=M/A.

The probability grid generator 106 can adjust and/or calibrate the probability calculations described above to other sources, in order to provide additional reliability and/or precision.

The system 100 also includes a target indicator capability module 110, which receives the respondent probability grid 108 as input, and which generates and assigns analysis filter indicators 112 to the respondent probability grid 108 (see, also, FIG. 2, operation 204). The target indicator capability module 110 can, for example, assign any one or more of the following indicators to the respondent probability grid 108:
(a) Number of addressable households represented by the respondent probability grid 108.
(b) Number of addressable households represented by the respondent probability grid 108 which satisfy a particular criterion or criteria, referred to herein as “in-target households” (e.g., the number of addressable homes represented by the respondent probability grid 108 that contain an auto enthusiast who is between 25 and 54 years old).
(c) Number of persons in the addressable in-target households identified above (e.g., all persons in addressable households that contain an auto enthusiast who is between 25 and 54 years old).
(d) Number of in-target persons represented by the respondent probability grid 108 (e.g., number of auto enthusiasts who are between 25 and 54 years old).
(e) Any other required and/or desired classification(s), such as a demo target relevant to the schedule.

The system 100 also includes a target population size calculation module 114, which receives the analysis filter indicators 112 as input, and which calculates and produces as output, based on the analysis filter indicators 112, a grid of target population size estimates 116 (see, also, FIG. 2, operation 206). Table 1, below, is an example of the target population size estimates 116 in one embodiment, containing two axes:
(1) Household types (along the “Y-axis”):
   a. All Homes
   b. Addressable Homes
   c. Addressable In-Target Homes
(2) Population Type (along the “X-axis”):
   a. Persons 2+: the number of people in the households who are at least two years old
   b. Adults 18+: the number of people in the households who are at least 18 years old
   c. HH: the number of households
   d. Target: the number of people in the households who satisfy the target
   e. Target: % of P2+: the number of people in the households who satisfy the target as a percentage of the number of people in the households who are at least two years old
   f. Target: % of A18+: the number of people in the households who satisfy the target as a percentage of the number of people in the households who are at least 18 years old

Table 1, below, shows an example of results in which the target is an auto enthusiast who is at least 18 years old.

TABLE 1

| | Universe Estimates (000s) | | | | | |
|---|---|---|---|---|---|---|
| | Persons | Adults | | | Target: | Target: |
| | 2+ | 18+ | HH | Target | % of P2+ | % of A18+ |
| All | 305,438 | 241,408 | 106,502 | 21,489 | 7% | 9% |
| Homes | | | | | | |
| Addressable | 258,323 | 200,136 | 83,690 | 18,063 | 7% | 9% |
| Homes | | | | | | |
| Addressable | 54,361 | 42,067 | 17,914 | 18,063 | 33% | 43% |
| In-Target | | | | | | |
| Homes | | | | | | |

The system 100 also receives addressable schedule details 118, which can, for example, be received from an external demand source and/or be generated from an optimizer in a schedule creation process. Examples of details which can be contained in the addressable schedule details 118 include:
Schedule Start Date
Schedule End Date (must be in the same time period as the Schedule Start Date)
Max Units per Home per Hour, where “Units” denotes advertising placements. This impacts the number of available units. The following discussion will assume a default value of 1 per hour.
Onscreen Target Impressions by Network j, referred to herein as Cⱼ.
Frequency Cap f, which is the maximum number of impressions by network, household, or device.

The system 100 also includes a probability and schedule integrator 120, which receives the respondent probability grid 108 and addressable schedule details 118 as inputs, and integrates them in a variety of ways to produce integrated flight (here, “flight” refers to the advertising units that comprise a partial or whole subset of an advertising campaign) calculation inputs 122 (see, also, FIG. 2, operation 208). For example, the probability and schedule integrator 120 can generate the flight calculation inputs 122 by:
(1) For each Network j, calculating the total available impressions Iⱼ=Campaign flight days×Hours×Max Units per Hour. For example, for a 91-day flight across Network 1, at all times, with a maximum of 1 unit per hour, Iⱼ=91×24×1=2184.
(2) For each Network j and each Home k, calculating the frequency-capped number of available homes Iⱼₖ=Min (Frequency Cap, Iⱼ×pⱼₖ), where pⱼₖ is the VOD probability for Network j and Home k. For example, if Home k has a VOD probability of 0.005 for Network j, then the available units for a 91-day, all time, 1 unit per hour network, with no frequency cap is calculated as Iⱼₖ=2184×0.005=10.92. If instead the frequency cap were 4, then Iⱼₖ=4.
(3) For all persons q in Home k and Network j, calculating the frequency-capped available impressions I_{jkq}=Iⱼₖ×p_{jkq}/pⱼₖ, where p_{jkq} is the VOD probability for Network j for Person q in Home k. Note that this step preserves the Viewers per Viewing Home (VPVH) in each Home after frequency capping. As an example, assume that pⱼₖ=0.005, Iⱼₖ=4, pⱼₖ₁=0.004, and pⱼₖ₂2=0.003 for persons 1 and 2 in this 2-person household. In this case, Iⱼₖ₁=4×0.004/0.005=3.2 and Iⱼₖ₂=4×0.003/0.005=2.4.
(4) For each Home k and Network j, calculating the frequency-capped unique available impressions Uⱼₖ=Min(1, Iⱼₖ). For example, if a Home k has 10 available units for Network j, Iⱼₖ=10, and Uⱼₖ=1. If a Home k has 0.3 available units for Network j, then Iⱼₖ=0.3, and Uⱼₖ=0.3.
(5) For all Persons q in Home k by Network j, calculating the frequency-capped unique available impressions U_{jkq}=Min(1, I_{jkq}). For example, if a Person q has 10 available units for Network j, then I_{jkq}=10, and U_{jkq}=1. As another example, if a Person q has 0.3 available units for Network j, then I_{jkq}=0.3, and U_{jkq}=0.3.
(6) For each Network j, calculating the total available frequency-capped Target Homes addressable by Network j as Tⱼ=Σ(wₖIⱼₖ), where wₖ is the weight for Home k.
(7) For each Network j, calculating the flight sampling fraction for Network j as Fⱼ=Cⱼ/Tⱼ. The reason for calculating this fraction is that only a fraction of the total available Target Homes Impressions will be used in this campaign flight.
(8) For each Target Home k and each Network j, assign the Total Flight Exposures Eⱼₖ=Iⱼₖ×Fⱼ. In other words, the Total Flight Exposures for Home k and Network j is calculated by multiplying the frequency-capped available impressions by the flight sampling fraction for Network j.
(9) For Persons q in Target Homes k and for each Network j, calculate the Total Flight Exposures E_{jkq} by multiplying the frequency-capped available impressions (I_{jkq}) by the flight sampling fraction (Fⱼ) for each Network j.
(10) Assign the Unique Flight Exposures Vⱼₖ for each home k and each Network j as follows. The probability of unique exposure for each home follows a Poisson process, which is then adjusted by the frequency capping. Given an expected n exposures, the probability of zero exposures=e⁻ⁿ, where e is the root of the natural logarithm≈2.71828. This means that the reached probability=p(not zero)=1−e^{-a}. The frequency capping constraint means we adjust this so that the frequency is not greater than the cap. So the unique exposure probability=max(1−e⁻ⁿ, Exposures/frequency cap). For our purposes, Vⱼₖ=max(1−e^{-Ejk}, Eⱼₖ/f) for each Network/and Home k.
(11) Assign Unique Flight Exposures V_{jkq} for each Person q and for each Network j and each Target Home k as V_{jkq}=max(1−e^{-Ejkq},E_{jkq}/f).

The system 100 also includes an addressable flight result generator 124, which receives the flight calculation inputs 122 as input and generates, based on some or all of the flight calculation inputs 122, a set of addressable flight results 126 (see, also, FIG. 2, operation 210). The addressable flight result generator 124 can generate the addressable flight results 126 in any of a variety of ways, such as by filtering the respondent-level total and unique exposures described above. More specifically, for example, the addressable flight result generator 124 can perform one or more of the following:
(1) Calculate, for each Home k in the target and each Network j, the Homes Total Impressions Hⱼ=Σ(wₖEⱼₖ), where wₖ is the weight for Home k. Note that Hⱼ should be equal to Cⱼ for each Network j, when calculated for all Homes in the target. If Hⱼ≠Cⱼ for any Network j, then the system 100 may generate an error.
(2) Calculate, for each Network j, the Persons Total Impressions Pⱼ. For Persons q in the target: Pⱼ=Σ(w_{kq}E_{jkq}), where w_{kq} is the weight for Person q. The set of persons in the target here will often be a subset of persons in the target home. For example, person 1 may be in the target, but person 2 in the same home may not be.
(3) Calculate, for each Network j, the Homes Unique Impressions Rⱼ. For Homes k in the target, Rⱼ=Σ(wₖVⱼₖ).
(4) Calculate, for each Network j, the Persons Unique Impressions Sⱼ. For Persons q in the target, Sⱼ=Σ(w_{kq}V_{jkq}).
(5) Calculate the Total Impressions across Networks as a simple sum of network impressions across the relevant networks j. H^{T}ⱼ=Σ(Hⱼ), where H^{T}ⱼ is the total homes impressions across required networks j. Similarly, P^{T}ⱼ=Σ(Pⱼ) is the total persons impressions across required networks j.
(6) Calculate the Unique Impressions across Networks as follows:
   a. Calculate the homes and persons unique probabilities across networks
      The unique exposures for homes and persons, Vⱼₖ and V_{jkq}, are equivalent to probabilities and can be combined (in a conventional manner of combining probabilities) to estimate overall exposure as follows:
         V^{T}ⱼₖ=1−Π(1−Vⱼₖ), where V^{T}ⱼₖ is the probability of exposure for Home k across Networks j and H denotes the product of the term (1−Vⱼₖ).
         Similarly:
         V^{T}_{jkq}=1−Π(1−V_{jkq}), where V^{T}_{jkq} is the probability of exposure for Person q across Networks j.
         Example 1: Home k has unique exposures across three networks, as follows:
         Network 1: 0.0001
         Network 2: 0.0005
         Network 3: 0.0002
         In this case, unique exposures across all three=1−[(1−0.0001)×(1−0.0005)×(1−0.0002)]=0.00079983
         Note: at these low probabilities the exposures are virtually additive, but at higher levels the calculation has more effect.
         Example 2: Home k has unique exposures across three networks, as follows:
         Network 1: 0.4
         Network 2: 0.5
         Network 3: 0.2
         In this case, unique exposures across all three=1−[(1−0.4)×(1−0.5)×(1−0.2)]=0.76
         Summed probabilities here give a value of 1.1, which is not a meaningful probability.
   b. Calculate the homes and persons Unique Impressions across Networks R^{T}ⱼ, for Homes k in the target and Networks j, as R^{T}ⱼ=Σ(wₖV^{T}ⱼₖ).
   c. Calculate the Persons Unique Impressions across Networks S^{T}ⱼ, for Persons q in the target and Networks j, as S^{T}ⱼ=Σ(w_{kq}V^{T}_{jkq}).
(7) Calculate a ratings percentage and a reach percentage. These can, for example, be calculated in known ways for the required analysis filters, such as in the following manner:
   Ratings=100×Total Impressions/Universe Estimate
   Reach %=100×Unique Impressions/Universe Estimate
   In one embodiment, H^{T%}ⱼ=100×H^{T}ⱼ/Σ(wₖ) is the total homes Ratings across required Networks j for target Homes k
   In one embodiment, P^{T%}ⱼ=100×P^{T}ⱼ/Σ(w_{kq}) is the total persons Ratings across required Networks j for target Persons q
   In one embodiment, R^{T%}ⱼ=100×R^{T}ⱼ/Σ(wₖ) is the total homes Reach % across required Networks j for target Homes k
   In one embodiment, S^{T%}ⱼ=100×S^{T}ⱼ/Σ(w_{kq}) is the total persons Reach % across required Networks j for target Persons q

The impressions, ratings and reach estimates delivered by various embodiments can then be used in the planning of advertising campaigns, where the results can be used to forecasts likely advertising exposure delivery, and/or for the reporting of addressable campaigns after they occur. In the case where the individual measurement component, for example from a people meter panel, also includes linear advertising measurement, the combined results of a linear and addressable campaign (often referred to as a “cross-platform campaign”) can be computed by integrating the results from one or more embodiments with standard methods for computing linear advertising exposure.

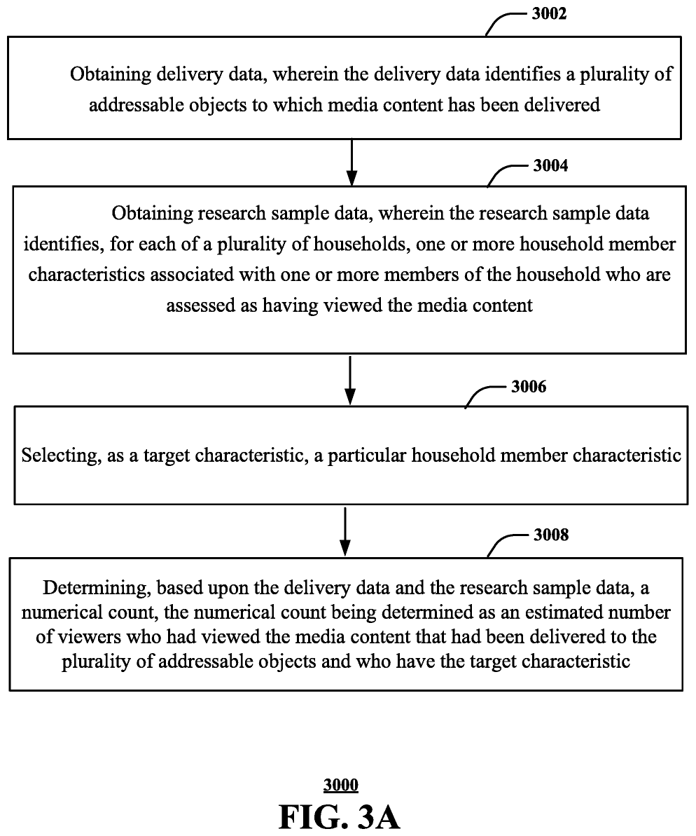

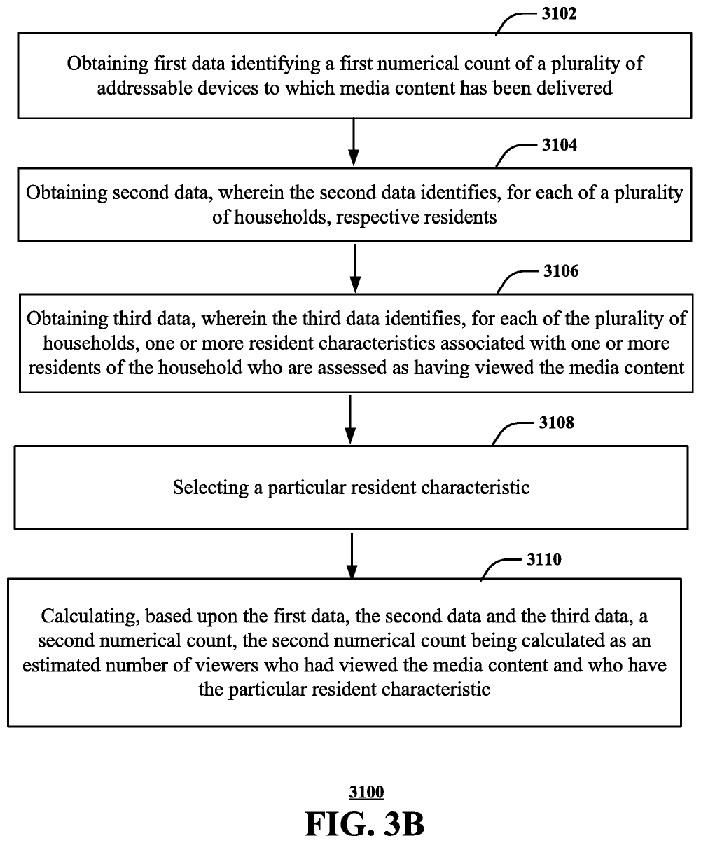

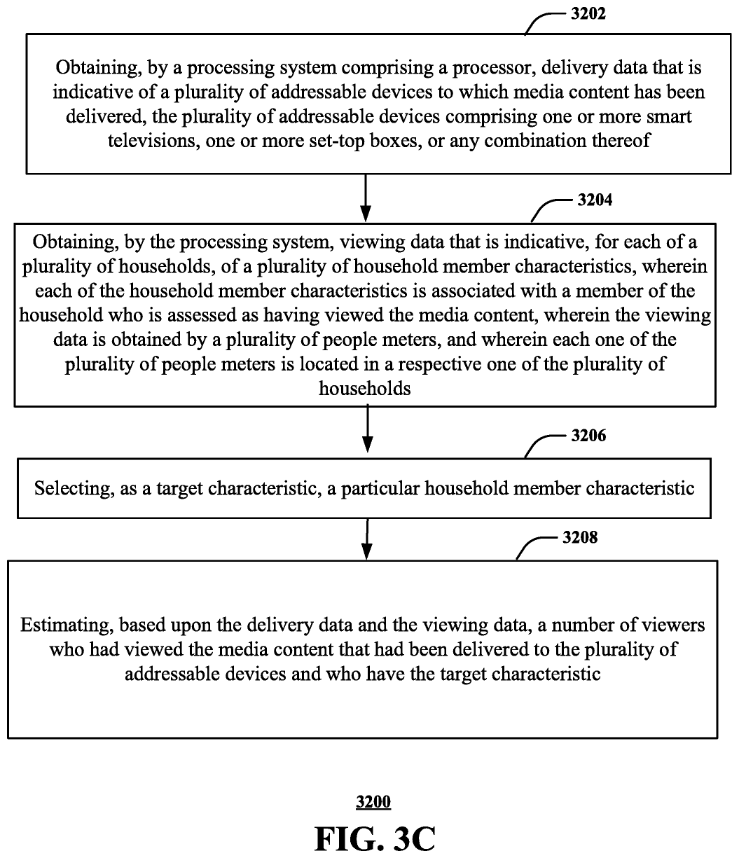

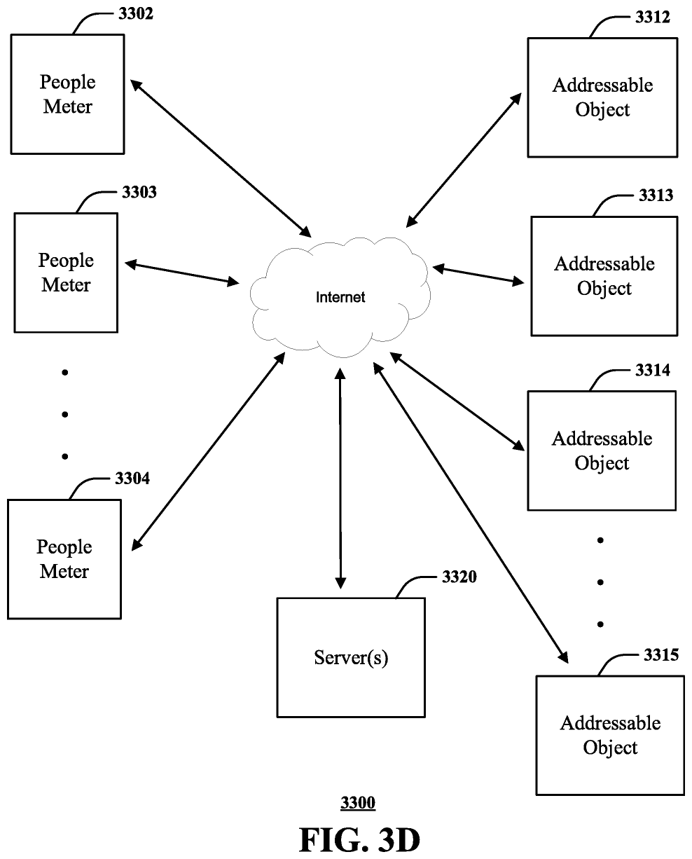

Referring now to FIG. 3A, various steps of a method 3000 according to an embodiment are shown. As seen in this FIG. 3A, step 3002 comprises obtaining delivery data, wherein the delivery data identifies a plurality of addressable objects (see, e.g., the addressable objects of FIG. 3D) to which media content has been delivered. In one example, the delivery data can identify each addressable object, each piece of media content, or any combination thereof. In one example, each piece of media content can comprise an advertisement or a program (e.g., movie, television series, sporting event). In one example, this delivery data can be obtained periodically (e.g., at any desired schedule or timing). Next, step 3004 comprises obtaining research sample data, wherein the research sample data identifies, for each of a plurality of households, one or more household member characteristics associated with one or more members of the household who are assessed (e.g., measured and/or estimated) as having viewed the media content. In one example, the research sample data can be obtained from one or more people meters (see, e.g., the people meters of FIG. 3D). In one example, this research sample data can be obtained periodically (e.g., at any desired schedule or timing). Next, step 3006 comprises selecting, as a target characteristic, a particular household member characteristic. In one example, the target characteristic (the particular household member characteristic) can be selected based upon one or more advertiser requirements. Next, step 3008 comprises determining, based upon the delivery data and the research sample data, a numerical count, the numerical count being determined as an estimated number of viewers who had viewed the media content that had been delivered to the plurality of addressable objects and who have the target characteristic.

While for purposes of simplicity of explanation, the respective processes are shown and described as a series of blocks in FIG. 3A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 3B, various steps of a method 3100 according to an embodiment are shown. As seen in this FIG. 3B, step 3102 comprises obtaining first data identifying a first numerical count of a plurality of addressable devices (see, e.g., the addressable objects of FIG. 3D) to which media content has been delivered. In one example, the delivery data can identify each addressable device, each piece of media content, or any combination thereof. In one example, each piece of media content can comprise an advertisement or a program (e.g., movie, television series, sporting event). In one example, this first data can be obtained periodically (e.g., at any desired schedule or timing). Next, step 3104 comprises obtaining second data, wherein the second data identifies, for each of a plurality of households, respective residents. In one example, this second data can be obtained when each of a plurality of people meters or the like (see, e.g., the people meters of FIG. 3D) is configured and/or during use of each people meter or the like. Next, step 3106 comprises obtaining third data, wherein the third data identifies, for each of the plurality of households, one or more resident characteristics associated with one or more residents of the household who are assessed (e.g., measured and/or estimated) as having viewed the media content. In one example, this third data can be obtained, for each household, from a respective people meter or the like. In one example, this third data can be obtained periodically (e.g., at any desired schedule or timing). Next, step 3108 comprises selecting a particular resident characteristic. In one example, the particular resident characteristic can be selected based upon one or more advertiser requirements. Next, step 3110 comprises calculating, based upon the first data, the second data and the third data, a second numerical count, the second numerical count being calculated as an estimated number of viewers who had viewed the media content and who have the particular resident characteristic. In one example, the calculating is based upon the first data and the third data (without being based upon the second data).

While for purposes of simplicity of explanation, the respective processes are shown and described as a series of blocks in FIG. 3B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 3C, various steps of a method 3200 according to an embodiment are shown. As seen in this FIG. 3C, step 3202 comprises obtaining, by a processing system comprising a processor, delivery data that is indicative of a plurality of addressable devices (see, e.g., the addressable objects of FIG. 3D) to which media content has been delivered, the plurality of addressable devices comprising one or more smart televisions, one or more set-top boxes, or any combination thereof. In one example, the delivery data can identify each addressable device, each piece of media content, or any combination thereof. In one example, each piece of media content can comprise an advertisement or a program (e.g., movie, television series, sporting event). In one example, this delivery data can be obtained periodically (e.g., at any desired schedule or timing). Next, step 3304 comprises obtaining, by the processing system, viewing data that is indicative, for each of a plurality of households, of a plurality of household member characteristics, wherein each of the household member characteristics is associated with a member of the household who is assessed (e.g., measured and/or estimated) as having viewed the media content, wherein the viewing data is obtained by a plurality of people meters (see, e.g., FIG. 3D), and wherein each one of the plurality of people meters is located in a respective one of the plurality of households. In one example, this viewing data can be obtained when each of a plurality of people meters (see, e.g., the people meters of FIG. 3D) is configured and/or during use of each people meter. In another example, this viewing data can be obtained periodically (e.g., at any desired schedule or timing). Next, step 3306 comprises selecting, as a target characteristic, a particular household member characteristic. In one example, the target characteristic (the particular household member characteristic) can be selected based upon one or more advertiser requirements. Next, step 3308 comprises estimating, based upon the delivery data and the viewing data, a number of viewers who had viewed the media content that had been delivered to the plurality of addressable devices and who have the target characteristic.

While for purposes of simplicity of explanation, the respective processes are shown and described as a series of blocks in FIG. 3C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 3D, this is a block diagram of an example, non-limiting embodiment of a computing environment 3300 in accordance with various aspects described herein. As seen in this FIG., computing system 3300 comprises a plurality of people meters. Although three people meters 3302, 3303, 3304 are shown in this example, it is to be understood that any desired number of people meters can be utilized. Each of these people meters 3302, 3303, 3304 is configured for bi-directional communication with one or more servers 3320. The bi-directional communication of each people meter 3302, 3303, 3304 with each of the one or more servers 3320 can be by any desired communication channel or channels (e.g., wired and/or wireless). In the example shown in this FIG., the bi-directional communications of each people meter 3302, 33203, 3304 with each of the one or more servers 3320 are carried out via the Internet. In one example, each of the people meters 3302, 3303, 3304 can be located in a respective house (or other dwelling such as apartment, co-op, condominium, etc.). In one example, each of the people meters 3302, 3303, 3304 can report to the one or more servers 3320 viewing data associated with each member (and/or resident) of the respective household. In one example, the viewing data can be viewing data that has been calculated and/or viewing data that has been estimated. In one example, the viewing data can identify (e.g., for each member and/or resident of each household) what media content had been viewed and/or what media content has been assessed as being viewed).

Still referring to FIG. 3D, it is seen that computing system 3300 further comprises a plurality of addressable objects. Although four addressable objects 3312, 3313, 3314, 3315 are shown in this example, it is to be understood that any desired number of addressable objects can be utilized. Each of these addressable objects 3312, 3313, 3314, 3315 is configured for bi-directional communication with the one or more servers 3302. The bi-directional communication of each addressable object 3312, 3313, 3314, 3315 with each of the one or more servers 3320 can be by any desired communication channel or channels (e.g., wired and/or wireless). In the example shown in this FIG., the bi-directional communications of each addressable object 3312, 3313, 3314, 3315 with each of the one or more servers 3320 are carried out via the Internet. In one example, each of the addressable objects 3312, 3313, 3314, 3315 can be located in a respective house (or other dwelling such as apartment, co-op, condominium, etc.). In one example, each of the addressable objects 3312, 3313, 3314, 3315 comprises a television (e.g., a smart television), a set-top box, a desktop computer, a laptop computer, a tablet, a smartphone, or any combination thereof. In one example, each of the addressable objects 3312, 3313, 3314, 3315 can receive from the one or more servers 3320 media content (e.g., one or more advertisements and/or one or more programs (e.g., movie, television series, sporting event)).

Still referring to FIG. 3D, in one example, server(s) 3320 can comprise advertisement server(s), media content server(s), and/or data calculation server(s). In one example, server(s) 3320 can be configured to: receive information from the people meters 3302, 3303, 3304 (e.g., information regarding media content viewed (actually viewed and/or assessed (such as by estimation) as having been viewed) by each household member and/or resident); and calculate (based upon the information received from the people meters 3302, 3303, 3304 and based upon knowledge of what media content was delivered to each of the addressable objects 3312, 3313, 3314, 3315) various metrics described herein. In one example, one or more of server(s) 3320 can have knowledge of what media content was delivered to each of the addressable objects, because one or more of server(s) 3320 could have delivered the media content and/or could have facilitated delivery of the media content.

In various embodiments, in a case that an addressable object is a mobile phone (e.g., smartphone), a laptop computer, or a tablet, the specific person watching the screen can often be determined.

In various embodiments, a people meter can provide a research sample such as via a conventional NIELSEN system. In one specific example, the research sample results can vary from reality, and thus can be used as an estimate.

In various embodiments, based upon research sample data, an estimate of a large number of views can be made. For example, data can be extrapolated.

In various embodiments, aspects of addressable advertisements can be applied in the context of over-the-top (OTT) TV.

In various embodiments, aspects can be applied in the context of millions (or billions) of advertisement opportunities.

In various embodiments, frequency capping can be applied (e.g., to avoid over-advertising to a given household).

In various embodiments, a likelihood of a particular advertisement fitting in a particular advertisement space can be calculated.

In various embodiments, a particular person in a household can be identified.

In various embodiments, information and/or data can be known (e.g. historical) and/or forecast.

In various embodiments, a determination and/or an estimate can be made of how many people saw an advertisement.

In various embodiments, a determination and/or an estimate can be made of a total number of impressions made by an advertisement.

In one embodiment, a computer-implemented method comprises:
(A) receiving multi-signal data from a plurality of advertisement servers and panel-based individual measurement, representing known or forecast device activity of a plurality of content delivery devices; and
(B) estimating the number of unique exposures of an audience represented by at least one content descriptor to particular content, based on the multi-signal data.

As described herein, various embodiments can provide a computerized system that automatically estimates the number of times that people were exposed on-screen to particular content (e.g., television programs, advertisements, or other video or display content) using a statistical integration of multi-signal data from one or more advertisement servers (or other census-based estimates of activity, such as set-top boxes) and panel-based individual measurement. The result is more accurate measurements of content exposure by individual people than was possible with certain previous techniques.

It is to be understood that although particular embodiments have been described, such embodiments are provided as illustrative only. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described herein may be implemented, for example, in hardware, one or more computer programs tangibly stored on one or more computer-readable media, firmware, or any combination thereof. The techniques described herein may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Various embodiments include features which are only possible and/or feasible to implement with the use of one or more computers, computer processors, and/or other elements of a computer system. Such features are either impossible or impractical to implement mentally and/or manually. For example, various embodiments can automatically calculate a variety of metrics in a manner that would be infeasible or impossible for a human to perform for all but trivial amounts of data.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below can be implemented in any programming language, such as assembly language, machine language, a high-level procedural programming language, or an object-oriented programming language. The programming language can, for example, be a compiled or interpreted programming language.

Each such computer program can be implemented in a computer program product tangibly embodied in a machine-readable storage device for execution by a computer processor. Method steps can be performed by one or more computer processors executing a program tangibly embodied on a computer-readable medium to perform functions by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing can be supplemented by, or incorporated in, specially-designed ASICs (application-specific integrated circuits) or FPGAs (Field-Programmable Gate Arrays). A computer can generally also receive (read) programs and data from, and write (store) programs and data to, a storage medium such as an internal disk or a removable disk. Various embodiments can be used in conjunction with any digital print engine or marking engine, display monitor, or other raster output device capable of producing color or gray scale pixels on paper, film, display screen, or other output medium.

Any data disclosed herein can be implemented, for example, in one or more data structures tangibly stored on a medium. Various embodiments can store such data in such data structure(s) and read such data from such data structure(s).

Various embodiments can be implemented via computer-executable instructions that can run on one or more computers, and/or in combination with other program modules and/or as a combination of hardware and software.

Various embodiments can be implemented using various computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

Various embodiments can be implemented in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media.

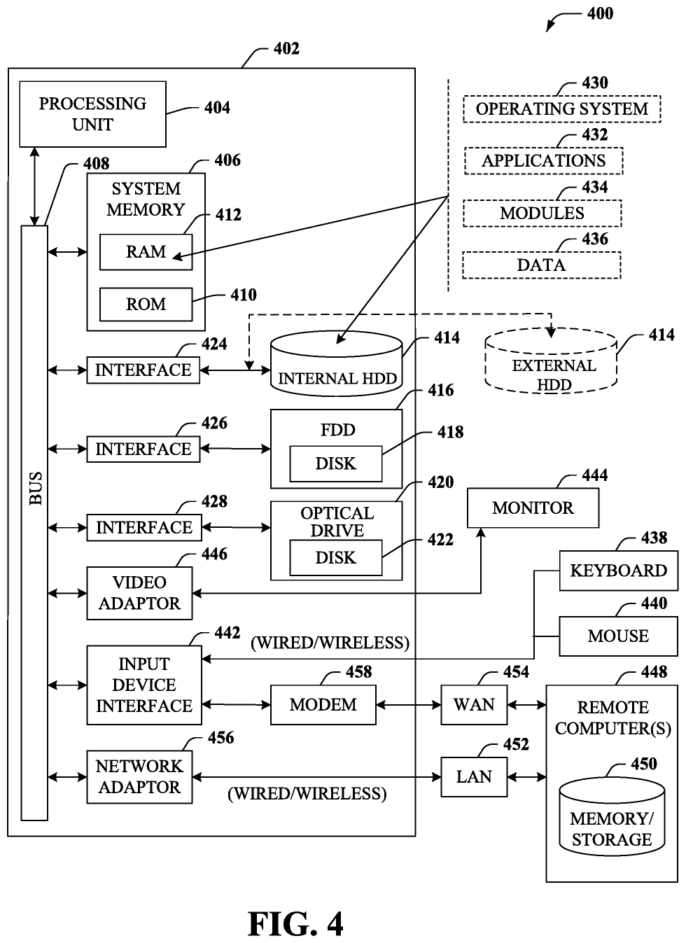

Referring now to FIG. 4, an example computing environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining delivery data, wherein the delivery data identifies a plurality of addressable objects to which media content has been delivered;
obtaining research sample data, wherein the research sample data identifies, for each of a plurality of households, one or more household member characteristics associated with one or more members of the household who are assessed as having viewed the media content;
selecting, as a target characteristic, a particular household member characteristic; and
determining, based upon the delivery data and the research sample data, a numerical count, the numerical count being determined as an estimated number of viewers who had viewed the media content that had been delivered to the plurality of addressable objects and who have the target characteristic.

2. The device of claim 1, wherein the plurality of addressable objects comprises a plurality of addressable televisions, a plurality of set-top boxes, or any combination thereof.

3. The device of claim 1, wherein:
the research sample data is obtained from a plurality of dedicated research devices;
each of the plurality of dedicated research devices in located at a respective one of the plurality of households; and
for each of the plurality of households, the one or more members of the household being assessed as having viewed the media content results in an assessment, the assessment being based upon one or more probabilities.

4. The device of claim 3, wherein:
the delivery data is obtained from the plurality of addressable objects; and
each of the plurality of dedicated research devices comprises a people meter.

5. The device of claim 3, wherein:
a first number of the plurality of dedicated research devices is less than a second number of the plurality of addressable objects; and
the numerical count is greater than the first number and less than the second number.

6. The device of claim 1, wherein the target characteristic comprises an age, an age range, a gender, a hobby, a like, an association with an organization, a job, a profession, an income, an income range, or any combination thereof.

7. The device of claim 1, wherein, for each of the plurality of households, the one or more members of the household are assessed as having viewed the media content based upon information provided by at least one of the one or more members of the household.

8. The device of claim 7, wherein the information is provided via use of a plurality of people meters.

9. The device of claim 8, wherein the information is provided before viewing of the media content, during viewing of the media content, after viewing of the media content, or any combination thereof.

10. The device of claim 1, wherein the delivery data identifies another numerical count of the plurality of addressable objects to which the media content has been delivered.

11. The device of claim 1, wherein the media content comprises one or more advertisements, one or more programs, or any combination thereof.

12. The device of claim 1, wherein the media content comprises one or more advertisements, and wherein the delivery data is obtained from one or more advertisement servers.

13. The device of claim 12, wherein the one or more advertisement servers facilitate providing the one or more advertisements to the plurality of addressable objects.

14. The device of claim 1, wherein the device comprises one or more advertisement servers, one or more media content servers, or any combination thereof.

15. The device of claim 1, wherein:
the operations further comprise obtaining household membership data, the household membership data identifying, for each of the plurality of households, each member of the household;
the determining being further based upon the household membership data; and
the estimated number of viewers who had viewed the media content that had been delivered to the plurality of addressable objects and who have the target characteristic is an estimated number of unique viewers.

16. A machine-readable storage medium comprising executable instructions that, when executed by a processing system including a processor, facilitate performance of operations, the operations comprising:
obtaining first data identifying a first numerical count of a plurality of addressable devices to which media content has been delivered;
obtaining second data, wherein the second data identifies, for each of a plurality of households, respective residents;
obtaining third data, wherein the third data identifies, for each of the plurality of households, one or more resident characteristics associated with one or more residents of the household who are assessed as having viewed the media content;
selecting a particular resident characteristic; and
calculating, based upon the first data, the second data and the third data, a second numerical count, the second numerical count being calculated as an estimated number of viewers who had viewed the media content and who have the particular resident characteristic.

17. The machine-readable storage medium of claim 16, wherein the calculating comprises interpolation such that the second numerical count is smaller than the first numerical count.

18. The machine-readable storage medium of claim 16, wherein the calculating comprises extrapolation such that the second numerical count is larger than the first numerical count.

19. A method comprising:
obtaining, by a processing system comprising a processor, delivery data that is indicative of a plurality of addressable devices to which media content has been delivered, the plurality of addressable devices comprising one or more smart televisions, one or more set-top boxes, or any combination thereof;
obtaining, by the processing system, viewing data that is indicative, for each of a plurality of households, of a plurality of household member characteristics, wherein each of the household member characteristics is associated with a member of the household who is assessed as having viewed the media content, wherein the viewing data is obtained by a plurality of people meters, and wherein each one of the plurality of people meters is located in a respective one of the plurality of households;
selecting, as a target characteristic, a particular household member characteristic; and
estimating, based upon the delivery data and the viewing data, a number of viewers who had viewed the media content that had been delivered to the plurality of addressable devices and who have the target characteristic.

20. The method of claim 19, wherein, for each of the plurality of households, each member is part of a same family.
